(19) United States
(12) Patent Application Publication
(10) Pub. No.: US 2001/0035400 A1
(43) Pub. Date: Nov. 1, 2001

(54) Method for sundering semiconductor materials

(76) Inventors: Andreas Gartner, Melbourne, FL (US); Anthony P. Pappalardo, Palm Bay, FL (US)

Correspondence Address: Andreas Gartner, 1640 Harlock Rd., Melbourne, FL, 32934, US

(21) Appl. No.: 09/845,792

(22) Filed: Apr. 30, 2001

Related U.S. Application Data
(60) Provisional application No. 60/202,505, filed on May 5, 2000.

(51) Int. Cl. B23K 26/40

(52) U.S. Cl. 219/121.72

(57) ABSTRACT

This invention relates to a method for sundering semiconductor materials. The interesting optical properties of semiconducting materials such as monocrystalline Silicon, Gallium arsenide (GaAs) and Indium phosphide (InP) and epitaxial materials such as InGaP/GaAs, InP/InGaAs, AlGaAs/GaAs, InAlAs/InGaAs as well as SOS (Silicon on Sapphire) are sufficiently similar to employ a general technique according to this invention with only minor modifications for the individual materials. This invention is using electromagnetic radiation in the far-infrared, a wavelength known to have comparably small extinction coefficients in the particular group of materials. This invention describes a method to couple the effects of weak absorption, temperature dependency of the adsorption and incoherent internal reflection to create sufficient stress in the material to extend an initially surface bound rupture throughout the material.

### FEDERALLY SPONSORED RESEARCH OR DEVELOPMENT

No federal funds were used in regard with this invention.

### BACKGROUND OF THE INVENTION

Numerous methods have been described in prior art to score, scribe, thermally shear and separate semiconductor materials. Bergmann (U.S. Pat. No. 3,894,208) taught a method of cooling the material or the area to be machined to a temperature possibly in the vicinity of absolute Zero and machine thereafter with an energy beam to thereby transform the solid material immediately to a gaseous state without passing through liquid state, and removing said portion of solid material in the gaseous state. Gates et al. (U.S. Pat. No. 3,970,819) describes a method to apply a laser beam to the backside of a wafer to render the thickness of the wafer in the area treated by the laser into a non-crystalline material having a breaking strength less than the breaking strength of the original material. The laser beam renders substantially all of the thickness of the wafer in the area under the beam molten. The molten region is permitted to resolidify into a non-crystalline material. Tijburg et al. (U.S. Pat. No. 4,224,101) taught a method to form grooves between adjacent desired structures by using a laser beam to evaporate the material and then selectively remove the polluting particles from the major surface of the semiconductor disk by preferentially chemical etching the non-monocrystalline material.

Takeuchi (U.S. Pat. No. 4,543,464) taught a method to scribe a semiconductor wafer with a laser beam without causing microcracks. According to this invention, there is provided an apparatus for scribing a semiconductor wafer with a laser beam, comprising an XY table for placing the semiconductor wafer thereon, a motor for driving the XY table, a laser beam oscillator provided above the XY table, an optical system for directing a laser beam form the oscillator onto the XY table. The apparatus of this invention scribes a semiconductor wafer in only one of the positive and negative directions of X and Y axes.

Gresser (U.S. Pat. No. 4,546,231) describes a method to provide a thin parting zone in a crystal material by focusing an energy beam on a point zone of energy absorbing material and successively scanning a predetermined parting zone. Taub et al. (U.S. Pat. No. 4,562,333) explored the “hot short condition” of materials by heating a seam of the material while keeping the remainder of the material outside of the hot short range. A force is then applied to the seam to cause the article to sever due to the brittleness of the material of the seam. Dekker et al (U.S. Pat. No. 5,084,604) taught a method of asymmetrically severing a plate of brittle material, in which by means of a heat source a thermal load is provided along a heating track asymmetrically with respect to the desired cutting line. Zonnefeld et al. (U.S. Pat. No. 5,132,505) taught a method to cleave a plate of brittle material by means of a radiation beam repeatedly moving over the plate. The radiation beam is repeatedly passed over a desired track until the plate has been cleaved along a desired line of rupture. Zappella (U.S. Pat. No. 5,214,261) used a deep ultraviolet exciter laser to dice semiconductor substrates by establishing guided relative motion between the beam and the substrate to achieve ablative photodecomposition with the angle between the beam and the substrate being approximately five degrees out of normal.

Cordingley (U.S. Pat. No. 5,300,756) taught a method to sever integrated circuit conductive links by laser, using a phase plate to shape the laser beam's intensity profile. The profile thus imparted to the beam approximates the Fourier transform of the intensity profile desired on the workpiece. As a consequence, when the a focusing lens receives a beam having the profile imparted by the phase plate it focuses that beam into a spot on the workpiece having an intensity profile more desirable than the ordinary Gaussian profile. Mueller et al. (U.S. Pat. No. 5,365,032) described a device for cutting material with laser radiation, whereby an anamorphic optical system is used to focus laser radiation along a focal line extending transversely to the direction of radiation. A cylinder lens is followed by a lens array, parallel to the focal line for resolving the focal line into individual focal spots. Wills et al. (U.S. Pat. No. 5,543,365) taught a technique to form grooves on a wafer. A channel of polysilicon is formed by a laser heating the material, which is subsequently cooled to form polysilicon. These streaks of polysilicon are formed around the die on either one side only or on opposing sides. The laser beam on one side of the silicon may provide a cut just sufficient to mark the surface of the silicon, while the laser on the opposing side may make a deep cut with respect to the depth of the silicon. A problem with the use of the laser making a deep cut is the amount of molten or slaging material.

Chadha (U.S. Pat. No. 5,641,416) is teaching a method to align a high energy beam with the cutting line and move either the beam or the wafer in the direction of cut so that the high energy beam passes over the substrate and penetrates the wafer to an intermediate depth along the length of the cutting line. The moving step is then repeated after each pass of the high energy beam over the wafer until the wafer is severed. Imoto et al. (U.S. Pat. No. 5,916,460) teaches a method to generate a continuous wave oscillating laser beam which is focused between the tip of the nozzle and the substrate surface. A flow of assist gas is supplied from a gas intake sorrounding the laser beam. The gas is blown onto the substrate under constant pressure to suppress generation of strains due to thermal deformation. Broekroelofs (U.S. Pat. No. 5,922,224) taught a method to form a score in a surface of a wafer through local evaporation of semiconductor material by heat originating from radiation. This radiation is generated by a laser and focused on the wafer. The wafer is moved relative to the radiation, formed by at least two beams.

Matsumoto (U.S. Pat. No. 5,968,382) described a method to cut a workpiece by locally cooling at least the area of the workpiece that included the starting point and to emit a laser beam to this point (preferably from the side of the workpiece opposite to the cooled surface). The area that includes the end point is also locally cooled within a range from 0 to −10 deg. C. An initial crack is formed and then a subsequent cut on the desired major surface can be conducted. Ostendarp et al. (U.S. Pat. No. 5,984,159) teaches heating the cutting line with a heat spot symmetrical to the cutting line, said heat radiation spot having edge portions of comparatively large radiation intensity and a maximum at the rear end thereof. The edge portions coincide with a V- or U-shaped curve open at the front in motion direction. Sawada (U.S. Pat. No. 6,023,039) describes a method to apply a pulse laser and shifting a pulse heating position on the substrate, whereby the substrate is cooled between pulses.

### SUMMARY OF THE INVENTION

This invention relates to a method for sundering semiconductor material. The interesting optical properties of semiconducting materials such as monocrystalline Silicon, Gallium arsenide (GaAs) and Indium phosphide (InP) and epitaxial materials such as InGaP/GaAs, InP/InGaAs, AlGaAs/GaAs, InAlAs/InGaAs as well as SOS (Silicon on Sapphire) are sufficiently similar to employ a general technique according to this invention with only minor modifications for the individual materials. By using electromagnetic radiation in the far-infrared, a wavelength known to have comparably small extinction coefficients in the particular material, the transmittance of these materials becomes strongly temperature dependant. This invention describes a method to couple the effects of weak absorption, temperature dependency of the adsorption and incoherent internal reflection to create sufficient stress in the material to extend an initially surface bound rupture throughout the material.

### DESCRIPTION OF DRAWINGS

FIG. 1 shows the process of adsorption and incoherent internal reflection in a substrate.

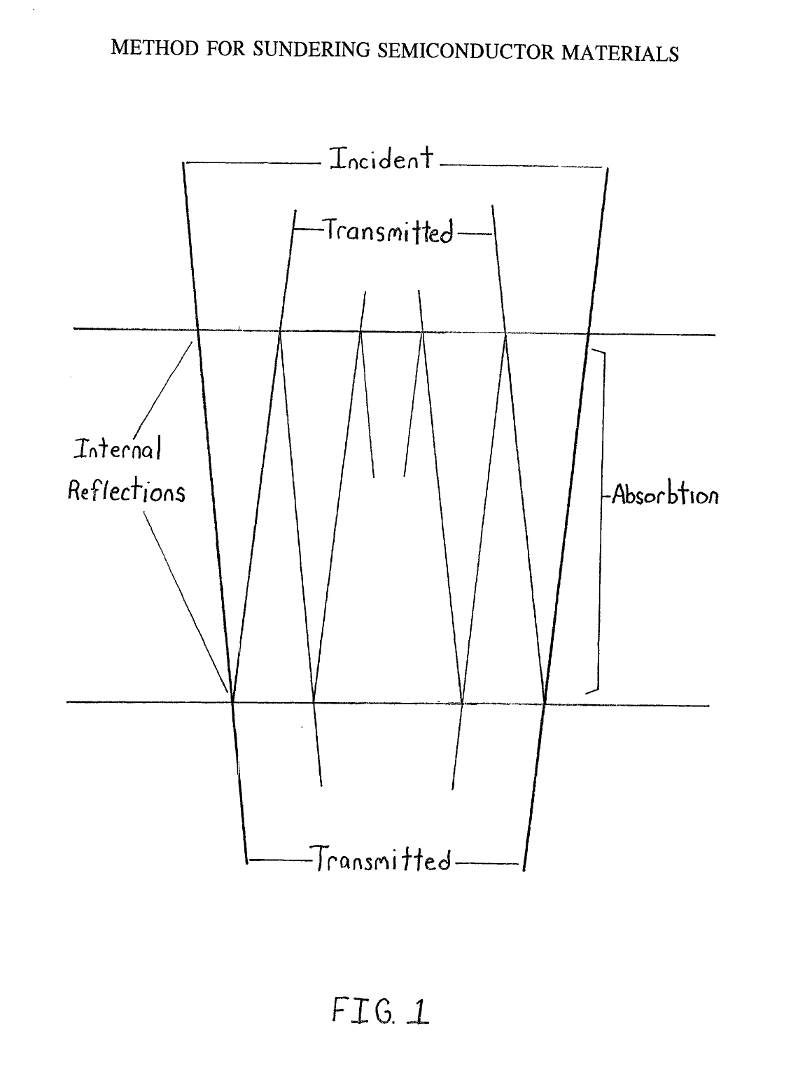

FIG. 2 shows the preferred embodiment, a radiation source 1, collimator 2, expander 3, shutter 4, substrate 5, balance system 6, optical elements 7 as well as the geometry of radiation impingement point relative to the balance system.

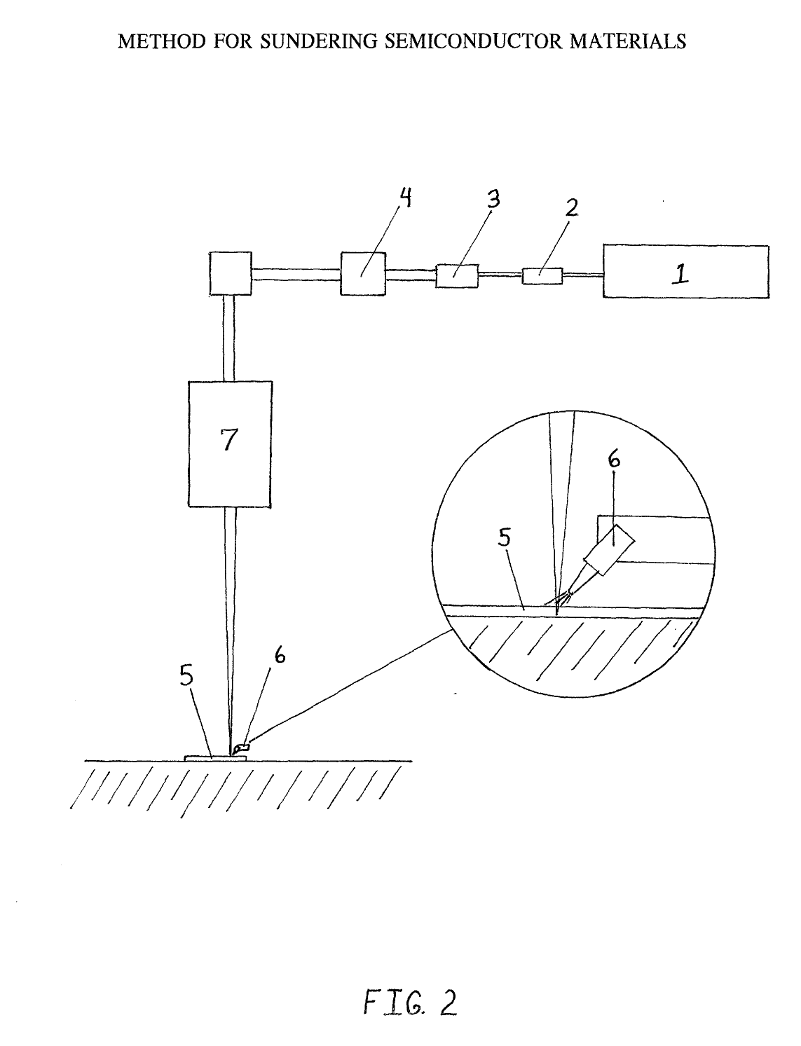

### DETAILED DESCRIPTION OF THE INVENTION

The velocity of radiation propagation through a solid material is governed by the frequency dependant complex refractive index N=n−ik whereby the real part n is a function of the velocity and k, the extinction coefficient, is a function of the damping of the oscillation amplitude. When radiation originating in air impinges on the surface of an optically transparent substrate, some of the radiation is reflected from the surface and some is transmitted into the material. As the power or intensity of an incident radiation through solid material is the conductivity multiplied by the square of the field vector, reduced by the damping factor, the term representing the fraction of the incident power that has been propagated from the initial position to a certain distance is then the negative product of 4 times pi times the frequency of the radiation times the extinction coefficient of the subject material times the distance in question, over the speed of light in vacuum, as a power of e. The absorption coefficient is therefore described as the reciprocal of the depth of penetration of a certain radiation into a bulk solid. Before the radiation will exit from the opposite side of incidence it undergoes a second reflection from the inside of the second surface boundary. This second reflection is further reflected back from the front surface again, producing multiple internal reflections. In the range of frequencies in which the absorption is weak the value of the reflection coefficient from the incident surface reduces to the ratio of the square of the refractivity minus 1 over the square of the refractivity plus 1. Where losses occur during the propagation of radiation through the material, the imaginary part of the complex refractivity index is added to the reflection coefficient as a frequency independent measure of uniformly attenuated radiation. The extinction coefficient will only be zero when the conductivity of the material is zero, i.e. the material is essentially loss-free. If the conductivity is not zero, and the material is not perfectly transparent or reflective then the radiation experiences a loss. All semiconductor materials mentioned in the preamble, but not limited to, are experiencing a loss. The primary loss, on the travel from point of incident to the point of reflection on the inner boundary surface heats the material just sufficiently that when a balance system, bound to the surface of incident, quenches the point of incident with a sufficiently heat removing media, a surface bound rupture opens which immediately travels down the path of primary loss and splits the material without generating debris or other cracks.

In a preferred embodiment of this invention, a radiation source with a wavelength of 10,600 nm is chosen. Certainly, this invention is not limited to this particular wavelength, as explained earlier. A person skilled in the art can easily adopt the method to a different radiation source. Using industrial radiation sources it was found helpful to initially collimate the beam and subsequently expand it again, to avoid artifacts of the radiation source or the optical system in the energy distribution. The radiation is directed under normal incidence angle to the substrate, triggering the interaction described earlier. A balance system with an overlap area percentage to the radiation impingement spot provides, by choice of a suitable media, sufficient heat removal to create tension in the upper part of the material ultimately leading to a fast traveling, initially surface bound rupture, which almost instantaneously follows the heat path throughout the thickness of the material and causes the material to sunder. Our experiments have shown that the distance D is a function of the extinction coefficient as well as the thermal conductivity of the material. Fast conducting materials require a comparably larger overlap area than slowly conducting materials. Another process control parameter is established by the choice of the media. Media with high thermal conductivity and low capacity such as Helium require a high flow rate to remove sufficient amounts of heat. Media with opposite properties such as a fine water mist in air provide better process control. The balance system remains at a constant position relative to the radiation impingement spot and displaces in parallel with the radiation source relative to the substrate.

It has further been shown experimentally, that when the substrate is displaced relative to the point of incidence, or the point of incidence is displaced relative to the substrate in an intended straight line, the resulting rupture will follow such straight line with remarkable precision as long as the mass of the material on the left side as well as on the right side of the indented straight line is approximately similar. This mass dependency is particularly dominant in materials with high thermal conductivity. In fact, on materials such as monocrystalline Silicon it has been found beneficial to arrange the intended sundering paths in a way to always split the available material in half. On a typical wafer, the first sundering path is put in a location as close as possible (dictated by the die pattern) to the middle of the substrate, resulting in two parts with similar (as far as the process is concerned) geometry. The next sundering path is located again in the middle of the part and so on until all parts according to the relevant die mask or die pattern have been sundered. If this method is not followed, the intended linear path deviates towards a bow shape, resulting in loss of usable material.

We claim:

1. A method to direct radiation of a frequency resulting in a low extinction coefficient to a semiconductor material, impinging the surface of said substrate under normal or almost normal angle of incidence, and causing weak absorption and incoherent internal reflection of said radiation inside the material.

2. The method of claim 1./ whereby a balance system is directed towards the point of incidence to remove heat in a rate as governed by the thermal capacity as well as thermal conductivity of the media.
a) A fine water mist with air as carrier is used as high capacity media.
b) Helium gas is used as high conductivity media.

3. A method where the use of radiation with a weak absorption rate in the particular material in conjunction with a balance system of sufficient heat removal ability is used to create a surface bound rupture which almost instantaneously propagates through the entire thickness of the material.

4. The method of claim 3./ whereby the relative position of the point of incidence and the point of heat removal are constant and both, in parallel, displace relative to an arbitrary point on the surface of the material.

5. A method to sunder highly conductive semiconductor materials in a way to maintain approximate mass balance on both sides of the intended sunder path.
